(19) United States
(12) Patent Application Publication
(10) Pub. No.: US 2006/0261612 A1
(43) Pub. Date: Nov. 23, 2006

(54) Pre-pregnated composite vehicle bumper comprising a grill guard and method for same

(76) Inventors: Mark C. Pratka, El Campo, TX (US); Brent M. Pratka, El Campo, TX (US); Celestino Puentes JR., El Campo, TX (US)

Correspondence Address: DUANE, MORRIS, LLP, 3200 SOUTHWEST FREEWAY, SUITE 3150, HOUSTON, TX, 77027, US

(21) Appl. No.: 11/386,124

(22) Filed: Mar. 22, 2006

Related U.S. Application Data
(60) Provisional application No. 60/664,229, filed on Mar. 22, 2005.

(51) Int. Cl. B60R 19/52

(52) U.S. Cl. 293/115

(57) ABSTRACT

A pre-pregnated composite vehicle bumper, which may have an integral or complementary grill guard, comprises an outer gel coat; a pre-pregnated composite material skin; and an internal two-part foam. The parts are typically created in a mold according to a process which includes closing and sealing an opened mold shell to define the volume of the shape of the bumper and the grill guard and then controllably increasing temperature of the closed and sealed mold shell until a predetermined temperature is reached, maintaining the predetermined temperature by controlling the predetermined temperature to be at a substantially steady state for a predetermined period of curing time, and then controllably decreasing the temperature of the closed and sealed mold shell until a predetermined temperature is obtained using a thermal control mold that incorporates both heating and cooling. The foregoing disclosure and description of the invention are illustrative and exemplary thereof, and various changes in the size, shape and materials, as well as in the details of the illustrated construction, may be made without departing from the spirit of the invention.

### FIELD OF THE INVENTION

This application claims priority to U.S. Provisional patent application Ser. No. 60/664,229 filed Mar. 22, 2005 and entitled “Pre-Pregnated Composite Vehicle Bumper Comprising A Grill Guard And Method For Same.”

### FIELD OF THE INVENTION

This invention relates to a pre-pregnated composite vehicle bumper which may have an integrated and/or a selectively attachable grill guard and a method of manufacturing the same comprising using a mold shell thermally controlled to quickly heat and cool the composite.

### BACKGROUND OF THE INVENTION

Carbon composite material use for structural parts has recently been the focus in the automobile industry because of their lightweight characteristic and potential for decrease vehicle fuel consumption when compared with the use of steel counterparts.

Existing composite structures comprising foam cores using composite fibers are commonly manufactured by a process that may use pre-pregnated composite fibers that are oven cured under a vacuum in order to cure the finished structure or by a process that may use dry composite fibers subsequently wetted with a thermoset resin using a resin transfer molding procedure that requires either an external heat and pressure source and/or an exothermic foam-forming resin injection system in order to cure the finished structure.

Existing composite structures and their manufacturing processes do not disclose a method or structure to manufacture a structurally sound and high-impact resistant pre-pregnated composite vehicle bumper comprising an easily installed or detachable grill guard which may have a large array of design styles and offer various functional degrees of protection to a front, end or side of a vehicle. Further, existing composite structures and their manufacturing processes do not disclose using a mold shell to define an internal volume shape of the bumper and the grill guard where the mold is adapted to quickly heat cure and quickly cool the bumper and grill guard so that the bumper and the grill guard can be easily mass produced.

It is known that pre-pregnated materials in the composites industry are composite sheets impregnated with a resin system to be heat cured.

### SUMMARY OF THE INVENTION

In light of the foregoing, the present invention relates to a pre-pregnated composite vehicle bumper and grill guard where the grill guard is preferably detachable from the bumper. The bumper and grill guard comprise an outer gel coat, a pre-pregnated composite material skin, and a two-part internal foam using a method comprising a mold shell thermally controlled to quickly heat and cool the composite.

### BRIEF DESCRIPTION OF THE DRAWINGS

A better understanding of the present invention can be obtained when the detailed description set forth below is reviewed in conjunction with the attached drawings depicting various embodiments of the present invention.

FIG. 1 is a view in partial cutaway perspective of an exemplary mold used in these processes;

FIGS. 2a and 2b are views in partial perspective of an exemplary integrated or attached bumper and guard;

FIG. 3 is a view in partial perspective of an exemplary dettached bumper and guard;

FIG. 4 is a schematic view of materials arranged for use in an exemplary mold; and

FIGS. 5 is a views in partial cutaway perspective and FIGS. 5a and 5b are views in partial perspective of voids and corresponding guard mating structures.

### DETAILED DESCRIPTION OF EXEMPLARY EMBODIMENTS

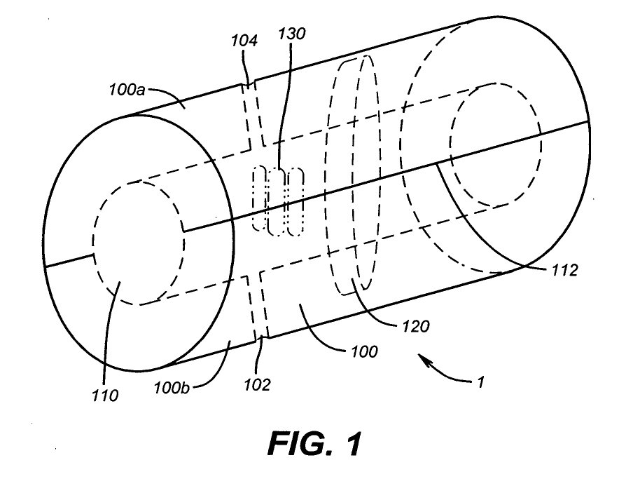

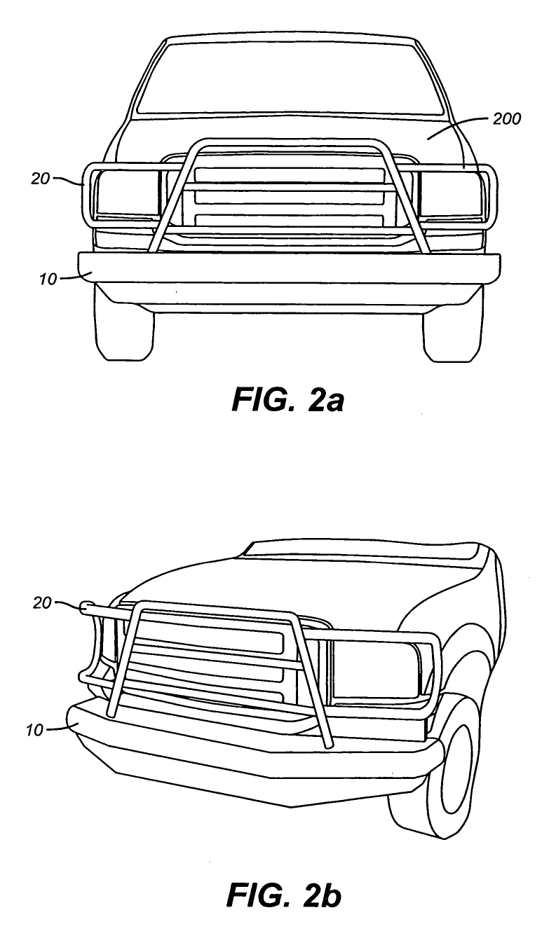

Referring now to FIG. 1, thermal control mold 1 is adapted for creating pre-pregnated composite vehicle bumper 10 (FIGS. 2a,2b) and comprises a selectively openable mold shell 100 adapted to be opened and closed into at least half sections 100a and 100b and further adapted for heat transfer operations; seal 112 in sealing arrangement with sections 100a and 100b; and controllable heater 120.

Mold shell comprises interior surface 110 adapted to accept a coating of a releasing agent, injection port 104 in fluid communication with interior surface 110, and mold shell weeping aperture 102 in fluid communication with interior surface 110.

Interior surface 110 of selectively openable mold shell 100 defines an internal volume shape of a first piece to be molded, e.g. pre-pregnated composite vehicle bumper 10 (FIGS. 2a,2b).

Thermal control mold 1 may further comprise a second mold shell 130 to define an internal volume shape of a second molded piece.

Controllable heater 120 is operatively disposed to heat material disposed within mold shell 100 to a first predetermined temperature and to controllably decrease the temperature to a second predetermined temperature. Cooling tubes and heating elements, e.g. 120, are inlaid in mold 1 for thermal control which may preferably be achieved using programmable thermal controllers 140, e.g. programmable thermal electric controllers.

Molds 1 are preferably constructed of fiberglass walls reinforced with carbon, wood, or metal backing.

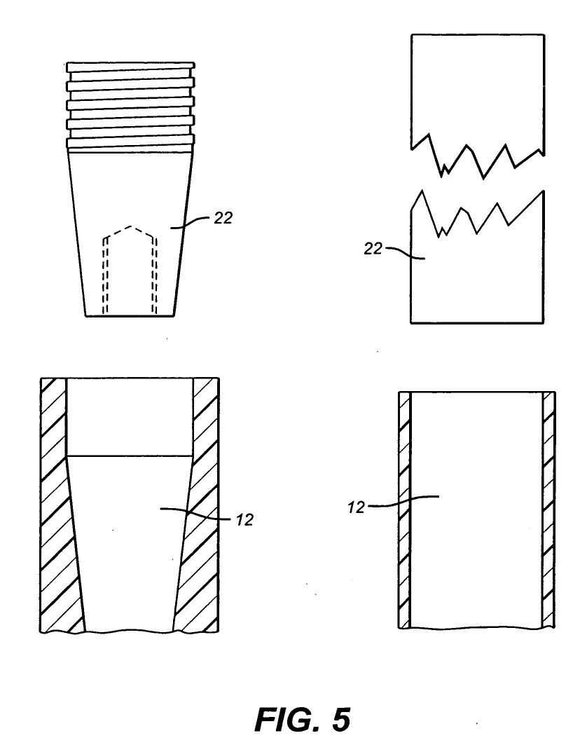

Referring now to FIGS. 2a,2b and FIG. 4, in a preferred embodiment of a bumper made in accordance with the present inventions, pre-pregnated composite vehicle bumper 10 and grill guard 20 will comprise outer gel coat 11 (FIG. 4); pre-pregnated composite material skin 12 (FIG. 4); and internal two-part foam 13, 14 (FIG. 4).

Pre-pregnated composite material skin 12 may further comprise first carbon layer 12b disposed at least partially in-between plurality of glass layers, e.g. 12a and 12c. In certain contemplated embodiments, carbon layer 12b comprises a 2×2 woven twill and at least one glass layer 12a, 12c comprises a mat with crossed fibers.

In a preferred embodiment, internal two-part foam layer 13,14 comprises aromatic isocyanate prepolymer foam layer part 13 and polyurethane foam layer part 14. These can be arranged in any relationship to pre-pregnated composite material skin 12.

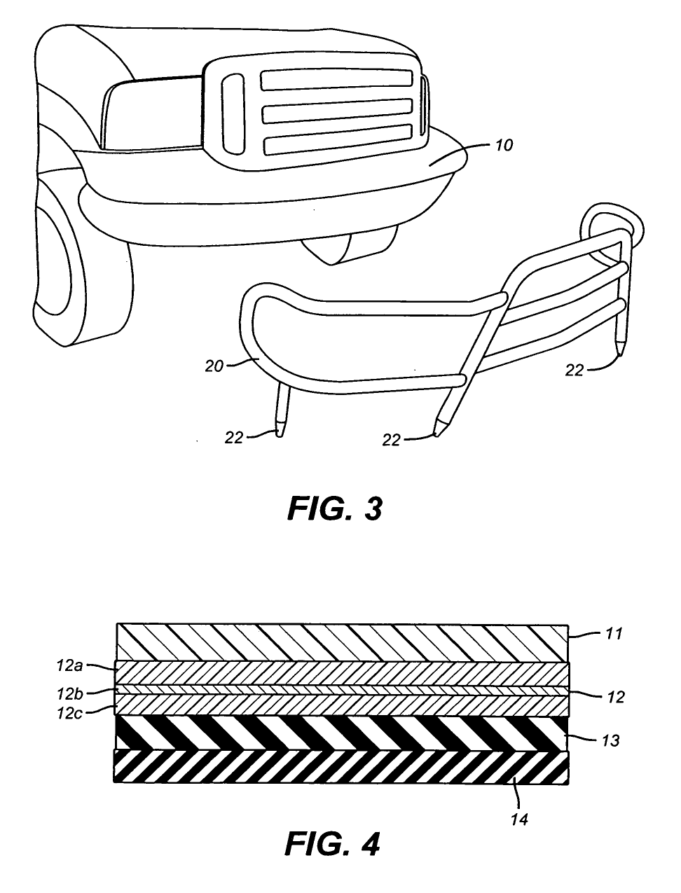

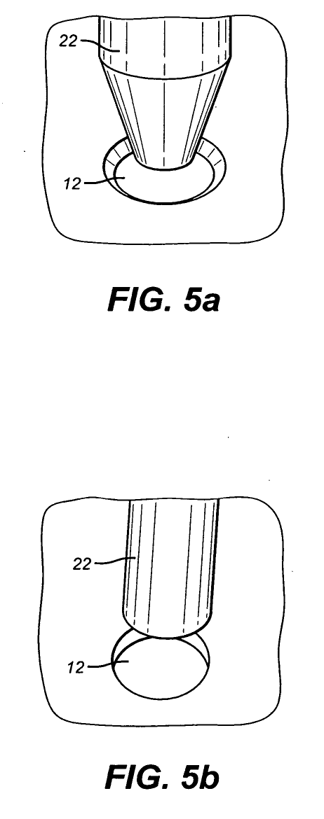

Referring now to FIG. 5, in a preferred embodiment, bumper 10 (FIG. 3)will have preferably have one or more generally conical or otherwise non-vertical walled indentions 12 disposed about the top surface of bumper 10 (FIG. 3) to accept similarly shaped sections 22 of grill guard 20. A plurality of voids 12 may therefore extend a predetermined distance from the top horizontal surface toward the bottom horizontal surface of bumper 10.

Referring to FIG. 3, in alternative embodiments, grill guard 20 may be molded as part of bumper 10 or may be molded separately from bumper 10 and set into place in a predetermined relationship to bumper 10, e.g. on top. If detachably mounted, grill guard 20 may comprise generally vertical members 22 which are shaped on the bottom end to conform to the inner measurements of indentations 12 (FIG. 5) on the top of bumper 10. This may allow grill guard 20 to be detachably mounted to bumper 10.

It should be understood that grill guard 20 may be securely attached to the bumper merely by placing the bottom portion of grill guard 20 into the matching indentions 12 (FIG. 5) in bumper 10. In alternative, detachable embodiments, grill guard 20 may further comprise a bolt or other fastener that protrudes from the bottom of the grill guard vertical member so that it will protrude through the indentations in the top of bumper 10 and allow secure fastening from the bottom of bumper 10. Alternatively, grill guard vertical member 22 may contain a hole or other indentation, including without limitation female threads, in the bottom side so that a fastener such as a bolt or other known fastener may be inserted through the indention in bumper 10 into the indention in grill guard vertical members 22 so that grill guard vertical member 22 is securely fastened to bumper 10.

In a the operation of a preferred embodiment, pre-pregnated composite bumper 10 may be molded with or without an integral or associated pre-pregnated composite grill guard 20 using mold shell 1 (FIG. 1) to define an internal, desired volume shape of bumper 10 (FIG. 2a,2b) and/or grill guard 20 (FIG. 2a,2b). In certain contemplated embodiments, grill guard 20 may be detachably mounted to bumper 10 after manufacture.

In a preferred embodiment, internal surface area 110 (FIG. 1) of opened mold shell 100 (FIG. 1) is coated with a releasing agent. When mold 1 (FIG. 1) is in the open position, a gel coat will preferably be applied to internal mold halves 100a,100b (FIG. 1), e.g. applied onto opened internal surface area 110 of opened mold shell 100 and a predetermined number of layers of pre-pregnated composite material laid in a predetermined orientation into opened mold shell 100 until interior surface area 110 of opened mold shell 100 is substantially covered. This gel coat may be clear or pigmented to create a variety of colors for a smooth external finish on parts. The pre-pregnated composite material laid into the mold halves 100a,100b may be carbon, fiberglass, or a combination of various other composite materials and will create desired structure and strength of molded shapes.

Opened mold shell 100 (FIG. 1) is closed and sealed to define the volume of the desired shape of bumper 10 (FIG. 3) and, in some embodiments, the desired volume and shape of grill guard 20 (FIG. 3). Preferably, mold halves 100a,100b are closed and fitted into position by use of dowel pins, clamps, bolts, or hydraulic function.

With the mating surfaces of mold halves 100a,100b (FIG. 1) are tightly sealed, mold 1 (FIG. 1) is injected with two-part foam 13,14 (FIG. 4) through one or more strategically placed injection ports 104 (FIG. 1). Using a calculated amount of foam material, foam 13,14 will preferably extrude out of one or more weep holes 102 (FIG. 1) on outer extremities of mold 1, thereby insuring that mold 1 is completely full. The expanding foam 13,14 compresses the pre-pregnated material against inner mold surfaces 110 (FIG. 1), forcing the material to conform to the shape of captured part. In preferred embodiments, cured foam remains in the shaped, cured part, resulting in a solid core and good structural strength.

As noted above, mold shell 100 (FIG. 1) is adapted for heat transfer operations that heat the material inside mold shell 100 (e.g., bumper 10 (FIG. 3) and grill guard 20 (FIG. 3)) while it is being formed and cured inside the closed mold shell 100 and then cool the formed part(s) (e.g., bumper 10 and grill guard 20) after they have cured. During the foam injection process, heater 120 (FIG. 1), under the control of thermal controls 140 (FIG. 1), will bring mold 1 up to resin cure temperature specifications. In an embodiment, the pre-pregnated composite material cures at around 145° F. and the predetermined temperature is maintained at around 200’ F.

When the cure time expires, thermal controller 140 (FIG. 1) and controllable heater 120 (FIG. 1) will cool mold 1 (FIG. 1) quickly, and mold will be opened to extract part. It is understood that controllable heater 120 is used to cool as well as to heat. Use of thermal controls 140 and controllable heater 120 on molds 1 allow mold 1 to be reloaded substantially immediately after removing parts. Not having to wait for natural cooling process by using thermal controls 140 and controllable heater 120 may be used to achieve maximum or near-maximum production. In typical embodiments, the predetermined period of curing time is around 1 hour and the controlled decreasing of the temperature occurs over a period of around 1 hour. The curing and cooling cycles may be controlled by, e.g., program logic controller 140, or the like, or manually adjusted.

After the desired shaped materials (e.g., bumper 10 (FIG. 3) and grill guard 20 (FIG. 3)) have been cured and cooled to a predetermined temperature, mold shell 100 (FIG. 1) is unsealed and opened and bumper 10 and grill guard 20 are extracted.

In one embodiment of the inventions, first mold shell 100 (FIG. 1) may be used to define the internal volume shape of bumper 10 (FIG. 3) and second mold shell used to define the internal volume shape of grill guard 20.

Mold parts are preferably coated with release agents to aid in extracting parts. Release agents are preferably re-applied during repeated mold use.

In a further method of molding a pre-pregnated composite vehicle bumper 10 (FIG. 3) and grill guard (FIG. 3) in mold shell 100 (FIG. 1) which defines an internal volume having a shape of bumper 10 and of grill guard 20, internal surface area 110 (FIG. 1) of opened mold shell 100 is coated with a releasing agent where mold shell 100 is as described herein above. A gel coat is applied to internal surface area 100 and a predetermined number of layers of pre-pregnated composite material laid in a predetermined orientation into opened mold shell 100 until interior surface area 110 of opened mold shell 100 is substantially covered. Opened mold shell 100 is closed and sealed to define the volume of the shape of bumper 10 and grill guard 20 and multi-part foam 13,14 (FIG. 4) injected into mold shell injection port 104 (FIG. 1) until multi-part foam 13,14 completely fills the defined volume of the shape of bumper 10 and grill guard 20 and a predetermined amount of multi-part foam 13,14 extrudes from mold shell weeping aperture 102 (FIG. 1). Temperature of the closed and sealed mold shell 100 is controllably increased until a predetermined temperature is reached and then that predetermined temperature maintained by controlling the predetermined temperature to be at a substantially steady state for a predetermined period of curing time. After the predetermined time, the temperature of closed and sealed mold shell 100 is controllably decreased until a second predetermined temperature is obtained at which time mold shell 100 is unsealed and opened. The cured molded composite vehicle bumper 10 and grill guard 20 are then extracted.

Molding of the pre-pregnated composite vehicle bumper 10 (FIG. 3) and the pre-pregnated composite detachable grill guard 20 (FIG. 3)may further comprise using first mold shell 100 to define the internal volume shape of bumper 10 and second mold shell 130 to define the internal volume shape of grill guard 20.

The foregoing disclosure and description of the invention are illustrative and exemplary thereof, and various changes in the size, shape and materials, as well as in the details of the illustrated construction, may be made without departing from the spirit of the invention.

What is claimed is:

1. A pre-pregnated composite vehicle bumper, comprising:
a. an outer gel coat;
b. a pre-pregnated composite material skin; and
c. an internal two-part foam.

2. The pre-pregnated composite vehicle bumper of claim 1, further comprising a plurality of voids extending from a top horizontal surface of the pre-pregnated composite vehicle bumper towards a bottom horizontal surface of the pre-pregnated composite vehicle bumper.

3. The pre-pregnated composite vehicle bumper of claim 1, further comprising a grill guard attached to the pre-pregnated composite vehicle bumper.

4. The pre-pregnated composite vehicle bumper of claim 3, wherein the grill guard is detachably mounted to the pre-pregnated composite vehicle bumper.

5. The pre-pregnated composite vehicle bumper of claim 1, wherein the pre-pregnated composite material skin further comprises a first carbon layer disposed at least partially in-between a plurality of glass layers.

6. The pre-pregnated composite vehicle bumper of claim 5, wherein the carbon layer comprises a 2×2 woven twill.

7. The pre-pregnated composite vehicle bumper of claim 5, wherein at least one glass layer comprises a mat with crossed fibers.

8. The pre-pregnated composite vehicle bumper of claim 1, wherein the internal two-part foam layer comprises:
a. an aromatic isocyanate prepolymer foam layer part; and
b. a polyurethane foam layer part.

9. A pre-pregnated composite vehicle bumper and detachable grill guard, comprising:
a. a pre-pregnated composite bumper, comprising:
1. an outer gel coat;
2. a pre-pregnated composite material skin;
3. an internal two-part foam; and
4. a plurality of voids extending from a top horizontal surface toward a bottom horizontal surface of the pre-pregnated composite bumper; and
b. a pre-pregnated composite grill guard attached to the pre-pregnated composite bumper, the pre-pregnated composite grill guard comprising a vertical member comprising a bottom portion with a cross sectional shape similar to the voids in the top horizontal surface of the bumper.

10. A method of molding a pre-pregnated composite vehicle bumper in a mold shell which defines an internal volume having a shape of the vehicle bumper, comprising:
a. coating an internal surface area of an opened mold shell with a releasing agent, the mold shell comprising an injection port and adapted to be opened and closed into at least half sections and further adapted for heat transfer operations;
b. applying a gel coat to the internal surface area of the opened mold shell;
c. laying a predetermined number of layers of pre-pregnated composite material in a predetermined orientation into the opened mold shell until the interior surface area of the opened mold shell is substantially covered;
d. closing and sealing the opened mold shell to define the volume of the shape of the bumper and the grill guard;
e. injecting a multi-part foam into a mold shell injection port until the multi-part foam completely fills the defined volume of the shape of the bumper and the grill guard and a predetermined amount of the multi-part foam extrudes from a mold shell weeping aperture;
f. controllably increasing temperature of the closed and sealed mold shell until a predetermined temperature is reached;
g. maintaining the predetermined temperature by controlling the predetermined temperature to be at a substantially steady state for a predetermined period of curing time;
h. controllably decreasing the temperature of the closed and sealed mold shell until a predetermined temperature is obtained;
i. unsealing and opening the mold shell; and
j. extracting the cured molded composite vehicle bumper shape and grill guard.

11. The method of claim 10, wherein the molding of the pre-pregnated composite vehicle bumper and the pre-pregnated composite detachable grill guard comprises using a first mold shell to define the internal volume shape of the bumper and a second mold shell to define the internal volume shape of the grill guard.

12. The method of claim 10, wherein the pre-pregnated composite material cures at around 145° F.

13. The method of claim 10, wherein the predetermined temperature is maintained at around 200° F.

14. The method of claim 10, wherein the predetermined period of curing time is around 1 hour, the controlled decreasing of the temperature occurs over a period of around 1 hour.

15. A method of molding a pre-pregnated composite vehicle bumper and grill guard in a mold shell which defines an internal volume having a shape of the bumper and of the grill guard, comprising:
a. coating an internal surface area of an opened mold shell with a releasing agent, the mold shell comprising an injection port and adapted to be opened and closed into at least half sections and further adapted for heat transfer operations;
b. applying a gel coat to the internal surface area of the opened mold shell;
c. laying a predetermined number of layers of pre-pregnated composite material in a predetermined orientation into the opened mold shell until the interior surface area of the opened mold shell is substantially covered;
d. closing and sealing the opened mold shell to define the volume of the shape of the bumper and the grill guard;
e. injecting a multi-part foam into a mold shell injection port until the multi-part foam completely fills the defined volume of the shape of the bumper and the grill guard and a predetermined amount of the multi-part foam extrudes from a mold shell weeping aperture;
f. controllably increasing temperature of the closed and sealed mold shell until a predetermined temperature is reached;
g. maintaining the predetermined temperature by controlling the predetermined temperature to be at a substantially steady state for a predetermined period of curing time;
h. controllably decreasing the temperature of the closed and sealed mold shell until a predetermined temperature is obtained;
i. unsealing and opening the mold shell; and
j. extracting the cured molded composite vehicle bumper shape and grill guard.

16. A thermal control mold for creating a pre-pregnated composite vehicle bumper, comprising:
a. a selectively openable mold shell adapted to be opened and closed into at least half sections and further adapted for heat transfer operations, the mold shell comprising:
1. an interior surface adapted to accept a coating of a releasing agent;
2. an injection port in fluid communication with the interior surface; and
3. a mold shell weeping aperture;
b. a seal in sealing arrangement with the at least half sections; and
c. a controllable heater operatively disposed to heat material disposed within the mold shell to a first predetermined temperature and to controllably decrease the temperature to a second predetermined temperature.

17. The thermal control mold of claim 13, wherein the selectively openable mold shell defines an internal volume shape of a first piece to be molded.

18. The thermal control mold of claim 13, further comprising a second mold shell to define an internal volume shape of a second molded piece.
